(19) United States
(12) Patent Application Publication
(10) Pub. No.: US 2016/0259908 A1
(43) Pub. Date: Sep. 8, 2016

(54) SYSTEM AND METHOD OF EMERGENCY TELEPSYCHIATRY USING EMERGENCY PSYCHIATRIC MENTAL STATE PREDICTION MODEL

(71) Applicant: UNIVERSITY-INDUSTRY COOPERATION GROUP OF KYUNG-HEE UNIVERSITY, Yongin-si, Gyeonggi-do (KR)

(72) Inventors: Choong Seon HONG, Yongin-si, Gyeonggi-do (KR); Golam Rabiul Alam MD, Yongin-si, Gyeonggi-do (KR); Eui Nam HUH, Yongin-si, Gyeonggi-do (KR); Eung Jun CHO, Yongin-si, Gyeonggi-do (KR)

(73) Assignee: UNIVERSITY-INDUSTRY COOPERATION GROUP OF KYUNG-HEE UNIVERSITY, Yongin-si, Gyeonggi-do (KR)

(21) Appl. No.: 14/429,913

(22) PCT Filed: Dec. 5, 2014
(86) PCT No.: PCT/KR2014/011895

§ 371 Date: Mar. 20, 2015

(30) Foreign Application Priority Data
Jun. 24, 2014 (KR) 10-2014-0077261

(51) Int. Cl. G06F 19/00; G06N 99/00; G06F 1/16; G06N 7/00

(52) U.S. Cl. CPC G06F 19/3418; G06N 7/005; G06N 99/005; G06F 1/163; G06F 19/322; G06F 19/345

(57) ABSTRACT

The present invention relates to an emergency psychiatric mental state prediction model-based emergency telepsychiatry system and a method for operating the same. The emergency telepsychiatry system can include a collection unit for collecting real-time mental health symptoms and medical and family history data of a patient, a prediction unit for predicting a psychiatric mental state of the patient from the collected real-time mental health symptoms and medical and family history data, and a transmission unit for providing the predicted psychiatric mental state of the patient.

### TECHNICAL FIELD

The present invention relates to an emergency psychiatric mental state prediction model-based emergency telepsychiatry system and a method for operating the same, and more particularly, to an emergency psychiatric mental state prediction model-based emergency telepsychiatry system which collects real-time mental health symptoms and medical and family history data of a patient to predict the patient's psychiatric mental state, and provides the patient, a doctor, and a medical institution such as a hospital or the like with the predicted psychiatric mental state, and a method for operating the same.

The application of the present invention was filed as a result of a research which was conducted during the period between Jul. 1, 2013 and Jun. 30, 2014 at a contribution rate of 100% by Industry Academic Cooperation Foundation of Kyunghee University (management organization) with the research business title of “Next Generation Information & Computing Technology Development Business” (grant number: 20131558) supported by Ministry of Science, ICT and Future Planning (ministry name) and National Research Foundation of Korea (NRF) (professional organizations of research and management) and with the research project title of “Real-Time M2M Network Management Technology”

### BACKGROUND ART

Cloud computing refers to a computer environment in which information is permanently stored in a server on the Internet and is temporarily stored in a client such as an IT device including a desktop, a tablet computer, a notebook computer, a netbook, a smart phone or the like. That is, the concept of the cloud computing is that all kinds of information on a user is stored in a cloud server on the Internet, and the information can be used through various IT devices anytime and anywhere.

In other words, the cloud computing is a computing service in which a user lends a desired computing resource such as a hardware/software existing in an intangible form like cloud in the sky and pays a charge for the lent computing resource. In addition, the cloud computing means a technology that integrates computing resources existing in different physical positions using a virtualization technology and provides the integrated computing resources to users. The cloud computing, which is an innovative computing technology providing IT-related services such as the storage and processing of data, the use of a network and contents, and the like at one time through a cloud server on the Internet represented by a cloud, is also defined as a “customized outsourcing service of IT resources using the Internet”.

Such a cloud server is roughly divided into a private cloud server and a public cloud server. The cloud server means a cloud server in which private enterprises construct a cloud environment in a data center in themselves. The public cloud server means a cloud server in which a provider (i.e., vendor) constructs a cloud environment and receives user fees while providing the cloud server to enterprises which need the cloud server.

The introduction of the clouding computing can enable an enterprise or an individual to reduce exorbitant time, manpower, and costs such as the cost spent to maintain, repair and manage a computer system and the cost spent to purchase and install a server, the update cost, a software purchase cost, etc. In addition, the introduction of the clouding computing can contribute to energy saving and thus the cloud server can be widely used in a variety of fields. In particular, in a healthcare field, the cloud server is used to collect and process a vast amount of healthcare information regarding users and freely inquire the healthcare information regarding users anytime and anywhere while operating in cooperation with a ubiquitous environment.

Meanwhile, the monitoring of a rapid change in the behavior of a patient with an emergency psychiatric disorder is one of the most important issues in an emergency psychiatry.

In recent years, a social concern on individuals having a potential suicide or murder risk is on an increasing trend. There is a need for a more accurate and rapid management of these individuals by reflecting this current of the times.

A cloud computing technology based on a body and a bio-sensor is useful in screening a patient with an emergency psychiatric disorder. The cloud computing technology enables a telematics platform-based psychiatric care.

### DISCLOSURE OF INVENTION

### Technical Problem

Accordingly, the present invention has been made to solve the above-mentioned problems occurring in the prior art, and it is an object of the present invention to provide an emergency psychiatric mental state prediction model-based emergency telepsychiatry system which collects real-time mental health symptoms and medical and family history data of a patient to predict the patient's psychiatric mental state, and provides the patient, a doctor, and a medical institution such as a hospital or the like with the predicted psychiatric mental state, and a method for operating the same.

### Technical Solution

To achieve the above object, in accordance with an embodiment of the present invention, there is provided an emergency telepsychiatry system including: a collection unit for collecting real-time mental health symptoms and medical and family history data of a patient; a prediction unit for predicting a psychiatric mental state of the patient from the collected real-time mental health symptoms and medical and family history data; and a transmission unit for providing the predicted psychiatric mental state of the patient.

In accordance with an embodiment of the present invention, the real-time mental health symptoms of the patient may be observed by at least one sensor positioned at a part of the patient's body and may be based on information regarding sensor observations which are integrated by a sink node.

In accordance with an embodiment of the present invention, the collection unit may collect the real-time mental health symptoms of the patient from a cloud service brokerage server, and collect the medical and family history data of the patient from a private cloud server in response to a request of the cloud service brokerage server.

In accordance with an embodiment of the present invention, the prediction unit may model the collected real-time mental health symptoms and medical and family history data as the discrete set of states of hidden Markov model (HMM) using the hidden Markov model (HMM), and predict the psychiatric mental state of the patient based on the modeled real-time mental health symptoms and medical and family history data.

In accordance with an embodiment of the present invention, the prediction unit may train a machine learning algorithm using results of observations of hidden Markov model (HMM) according to the modeling as parameters, and generate a psychiatric mental state sequence based on the trained machine learning algorithm.

In accordance with an embodiment of the present invention, the machine learning algorithm may include a Viterbi algorithm.

In accordance with an embodiment of the present invention, the prediction unit may predict the prognosis of an emergency psychiatric state from the generated psychiatric mental state sequence.

In accordance with another embodiment of the present invention, there is provided an emergency telepsychiatry system including: a collection unit for collecting real-time mental health symptoms of a patient; a request unit for requesting a private cloud server to transmit history information regarding the patient to a healthcare cloud server if the collected real-time mental health symptoms of the patient are authenticated; and a transmission unit for transmitting the collected real-time mental health symptoms of the patient to the healthcare cloud server, wherein the healthcare cloud server receives a predicted psychiatric mental state in response to the transmission of the collected real-time mental health symptoms of the patient from the transmission unit, and predicts the psychiatric mental state using the real-time mental health symptoms and the history information regarding the patient.

In accordance with another embodiment of the present invention, the history information regarding the patient may include at least one of medical data of the patient and family history data of the patient.

In accordance with another embodiment of the present invention, the healthcare cloud server may model the collected real-time mental health symptoms and medical and family history data as the discrete set of states of hidden Markov model (HMM) using the hidden Markov model (HMM), train a machine learning algorithm using results of observations of hidden Markov model (HMM) according to the modeling as parameters, and generate a psychiatric mental state sequence based on the trained machine learning algorithm to predict the psychiatric mental state of the patient.

In accordance with still another embodiment of the present invention, there is provided an emergency telepsychiatry system including: a collection unit for collecting real-time mental health symptoms of a patient, medical history data of the patient, and family history data of the patient; a modeling processing unit for modeling the collected real-time mental health symptoms and medical and family history data of the patient using a hidden Markov model (HMM); a training unit for training a machine learning algorithm using results of observations of hidden Markov model (HMM) according to the modeling as parameters; and a prediction unit for generating a psychiatric mental state sequence based on the trained machine learning algorithm to predict the psychiatric mental state of the patient.

In accordance with still another embodiment of the present invention, the modeling processing unit may model the collected real-time mental health symptoms and medical and family history data of the patient as the discrete set of states of hidden Markov model (HMM) using the hidden Markov model (HMM).

In accordance with still another embodiment of the present invention, the modeling processing unit may use a Viterbi algorithm as the machine learning algorithm.

In accordance with an embodiment of the present invention, there is provided a method for operating an emergency telepsychiatry system, the method including the steps of: allowing a collection unit to collect real-time mental health symptoms and medical and family history data of a patient allowing a prediction unit to predict a psychiatric mental state of the patient from the collected real-time mental health symptoms and medical and family history data; and allowing a transmission unit to providing the predicted psychiatric mental state.

In accordance with an embodiment of the present invention, the step of allowing a collection unit to collect real-time mental health symptoms and medical and family history data may include the steps of: collecting the real-time mental health symptoms from a cloud service brokerage server; and collecting the medical and family history data from a private cloud server in response to a request of the cloud service brokerage server.

In accordance with an embodiment of the present invention, the step of allowing a prediction unit to predict a psychiatric mental state of the patient may include the steps of: modeling the collected real-time mental health symptoms and medical and family history data as the discrete set of states of hidden Markov model (HMM) using the hidden Markov model (HMM); training a machine learning algorithm using results of observations of hidden Markov model (HMM) according to the modeling as parameters, and generating a psychiatric mental state sequence based on the trained machine learning algorithm.

### Advantageous Effects

The emergency telepsychiatry system according to the embodiments of the present invention as constructed above have the following advantageous effect. The real-time mental health symptoms and medical and family history data of a patient can be collected to predict the patient's psychiatric mental state, and the predicted psychiatric mental state can be provided to the patient, a doctor, and a medical institution such as a hospital or the like.

### BRIEF DESCRIPTION OF THE DRAWINGS

FIG. 1 is a diagrammatic view illustrating the entire system for an emergency telepsychiatry system in accordance with an embodiment of the present invention;

FIG. 2 is a block diagram illustrating the configuration of an emergency telepsychiatry system in accordance with an embodiment of the present invention;

FIG. 3 is a sequence diagram illustrating an interaction between and operating sequence of functional units of a system model accordance with an embodiment of the present invention

FIG. 4 is a diagrammatic view illustrating a hidden Markov model (HMM)-based mental state model for predicting an emergency psychiatric mental state;

FIG. 5 is a block diagram illustrating the configuration of an emergency telepsychiatry system in accordance with another embodiment of the present invention;

FIG. 6 is a block diagram illustrating the configuration of an emergency telepsychiatry system in accordance with still another embodiment of the present invention;

FIG. 7 is a flow chart illustrating a process for operating an emergency telepsychiatry system in accordance with an embodiment of the present invention; and

FIG. 8 is a flow chart illustrating a hidden Markov model (HMM)-based mental state modeling process.

### BEST MODE FOR CARRYING OUT THE INVENTION

Now, preferred embodiments of the present invention will be described hereinafter in detail with reference to the accompanying drawings.

The present invention is aimed to design a prototype of an emergency telepsychiatry having an ability to predict an emergency psychiatric mental state.

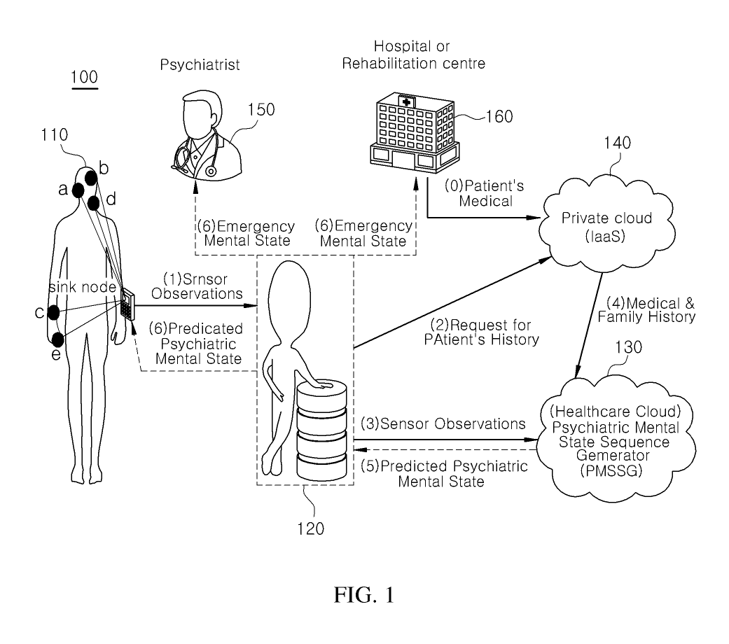

FIG. 1 is a diagrammatic view illustrating the entire system 100 for an emergency telepsychiatry system in accordance with an embodiment of the present invention.

The monitoring of a rapid change in the behavior of a patient with an emergency psychiatric disorder is one of the most important issues in an emergency psychiatry. The emergency telepsychiatry system enables the design of a prototype of an emergency telepsychiatry having an ability to predict an emergency psychiatric mental state. To this end, the entire system 100 can use an emergency psychiatric mental state prediction model for a scenario of the emergency telepsychiatry. As shown in FIG. 1, the entire system 100 includes a total of five units. In other words, the entire system 100 may include a wireless body area network (WBAN) 110, a cloud service brokerage (CSB) unit 120, a cloud service provider (CSP) unit 130, a hospital or rehabilitation center unit 160, a cloud computing unit 130 and 140, and a psychiatrist unit 150. For reference, the cloud computing unit 130 and 140 may include a private cloud 140 and a public cloud including the cloud service provider (CSP) unit 130.

First, the wireless body area network (WBAN) 110 can collect a patient's psychophysiological symptoms through a body and a bio-sensor. The psychophysiological symptoms is necessary for determining stress, depression, anxiety, irritation, respiratory rate, alcohol consumption level, etc.

In the present invention, the emergency telepsychiatry system includes a wireless body area network (WBAN) 110 having various types of body sensors and a sink node.

For example, the body sensors of the wireless body area network (WBAN) 110 are positioned at different sites of a body to collect signals through electrodes and transmit the collected signals to a sink node.

The body sensors of the wireless body area network (WBAN) 110 may include an electrodermal activity (EDA) sensor, an electroencephalography (EEG) sensor, a respiration sensor, and a blood volume pulse (BVP) sensor.

The electrodermal activity (EDA) sensor can measure a patient's stress level. In addition, the electroencephalography (EEG) sensor can measure a sleep disorder caused by a depression and a neuropsychiatric disorder. The respiration sensor can analyze a deep and fast breathing pattern to measure anger, stimulus, and anxiety. Further, the blood volume pulse (BVP) sensor can measure bloodstream, cardiac impulse change, and impulsiveness to monitor the emotional state of a patient.

Besides, a smart phone which is recently put on the market can function as a sink node of the wireless body area network (WBAN) 110.

For example, the sink node can perform a digital conversion, a filtering, an amplification and an analog conversion of a signal, and can perform a quantification using an observation preparing sequence and an interval dimension of the sensors.

In addition, psychiatric screening scale scores (e.g., PHQ-9, GAD-7, and BDI-II) of other mental state measurement ranges (e.g., PHQ, BHS, and BDI) of a patient can be collected using an application of the patient's smart phone in order to predict an emergency psychiatric mental state.

The cloud service brokerage (CSB) unit 120 can be operated between a patient and the cloud service provider (CSP) unit 130. The entities to which the cloud service brokerage (CSB) unit 120 transmits data may include a patient, a psychiatrist, a hospital, a private cloud, and a public cloud.

The cloud service provider (CSP) unit 130 in accordance with an embodiment of the present invention serves to maintain a network delivery service of a healthcare service which is requested

For example, the cloud service provider (CSP) unit 130 can acquire a patient's personal medical records, for example, age, sex, ethnicity, marital status, cohabitation status, duration of illness, drug abuse and misuse time, alcohol abuse and misuse period, and psychiatric mental state measurement scale scores such as, for example, PHQ, GAD, BPRS, SANS, SAPS, BDI-I, BDI-II, BHS, SCSI, RLI, and SSI from a private IaaS cloud of the hospital or rehabilitation center.

The cloud service brokerage (CSB) unit 120 receives signals indicative of sensor observations from the wireless body area network (WBAN) 110 and transmits the received signals to a healthcare cloud.

In addition, the cloud service brokerage (CSB) unit 120 request a patient's history from the private cloud, which can in turn transmit the patient's history containing an important patient record to the healthcare cloud.

In this case, it can be assumed that the patient's updated medical treatment record containing a patient family history and psychiatric screening scale scores, for example, PHQ-9, GAD-7, and BDI-II is previously stored in a database.

If the updated family history of a designated patient is previously stored in the healthcare cloud, the cloud service brokerage (CSB) unit 120 does not need to request the patient's family history from the private cloud.

If the healthcare cloud receives the patient's medical treatment, family and genetic history, it can extract proper features by integrating them. The healthcare cloud creates a psychiatric mental state sequence using a Viterbi machine learning algorithm based on the sensor observations and the extracted features.

In addition, the healthcare cloud analyzes the patient's emergency mental state from the created psychiatric mental state sequence and predicts the patient's emergency psychiatric mental state.

The healthcare cloud transmits the psychiatric mental state sequence and the predicted emergency psychiatric mental state to the cloud service brokerage (CSB) unit 120. The cloud service brokerage (CSB) unit 120 can receive from the predicted emergency psychiatric mental state from a healthcare cloud provider and transmit a result to a sink node of the wireless body area network (WBAN) 110.

The emergency psychiatric mental state is transmitted to a psychiatrist and a local server of a hospital, and then can be used as information for observing a patient having a psychiatric disorder.

The cloud service brokerage (CSB) unit 120 is required to be registered in a plurality of clouds and hospitals in order to maintain a service delivery network and a patient is required to be registered in the cloud service brokerage (CSB) unit 120 through the wireless body area network (WBAN) 110 of the patient before receiving a service.

The emergency telepsychiatry system is based on a multi-cloud architecture using the cloud computing technology.

A patient's personal medical records, for example, age, sex, ethnicity, marital status, cohabitation status, duration of illness, drug abuse and misuse time, alcohol abuse and misuse period, and psychiatric mental state measurement scale scores such as, for example, PHQ, GAD, BPRS, SANS, SAPS, BDI-I, BDI-II, BHS, SCSI, RLI, and SSI can be acquired from the private IaaS cloud of the hospital or rehabilitation center. In addition, the patient and patient's family record may be recorded in multiple private or public clouds.

The healthcare cloud service provider can integrate patient records through an intercloud communication process from diverse private or public clouds. In this case, the intercloud communication can be processed through an involvement of the cloud service brokerage (CSB) unit 120.

The healthcare cloud may include a mental state sequence generator (MSSG). The MSSG can be used to create a state sequence based on sensor observations provided by the cloud service brokerage (CSB) unit 120.

These features can be extracted from the patient records which can be confirmed in multiple clouds.

The MSSG can be developed by using a compute-as-a-service (CaaS) of the healthcare cloud. The compute-as-a-service (CaaS) is used in a probabilistic psychiatric mental state model.

A prognosis of an emergency psychiatric state can be predicted from the state sequence which can be created by an optimal threshold policy. The MSSG can be modeled through a hidden Markov model (HMM) employing a Viterbi Path Counting algorithm and a training. In addition, the MSSG can generate a posteriori psychiatric mental state sequence using the Viterbi algorithm.

The hospital or rehabilitation center unit includes an information storage means and a server, which can manage medical records and personal information of a patient.

An emergency hospital unit can store information regarding the patient in a light local server using an uploading schedule, and can update the medical records of the patient in an Infrastructure as a Service (IaaS) cloud.

The Iaas cloud can share essential medical records, a family history, and genetic records of a patient with the cloud service provider (CSP) unit 130 upon the request of the cloud service brokerage (CSB) unit 120. In this case, it is required that there should be a prior agreement between a patient, a hospital, the cloud service brokerage (CSB) unit 120, and the cloud service provider (CSP) unit 130.

The hospital or rehabilitation center unit can receive an emergency psychiatric mental state of a patient from the cloud service brokerage (CSB) unit 120, and can update the patient's records in a hospital local server. In addition, the hospital or rehabilitation center unit can provide a prompt and proper emergency psychiatric treatment to the patient.

In the present invention, the psychiatrist unit 150 may include a communication unit of an attending physician or a general physician.

A patient can receive a medical treatment.

The emergency telepsychiatry technology in accordance with the present invention enables the mental state of the patient to be reported using a notebook computer or a smart phone of a physician for the purpose of an emergency counseling through the cloud service brokerage (CSB) unit 120.

The cloud service brokerage (CSB) unit 120 can perform a ‘required accord’ so that a psychiatrist can carry out the transmission and authentication of security data.

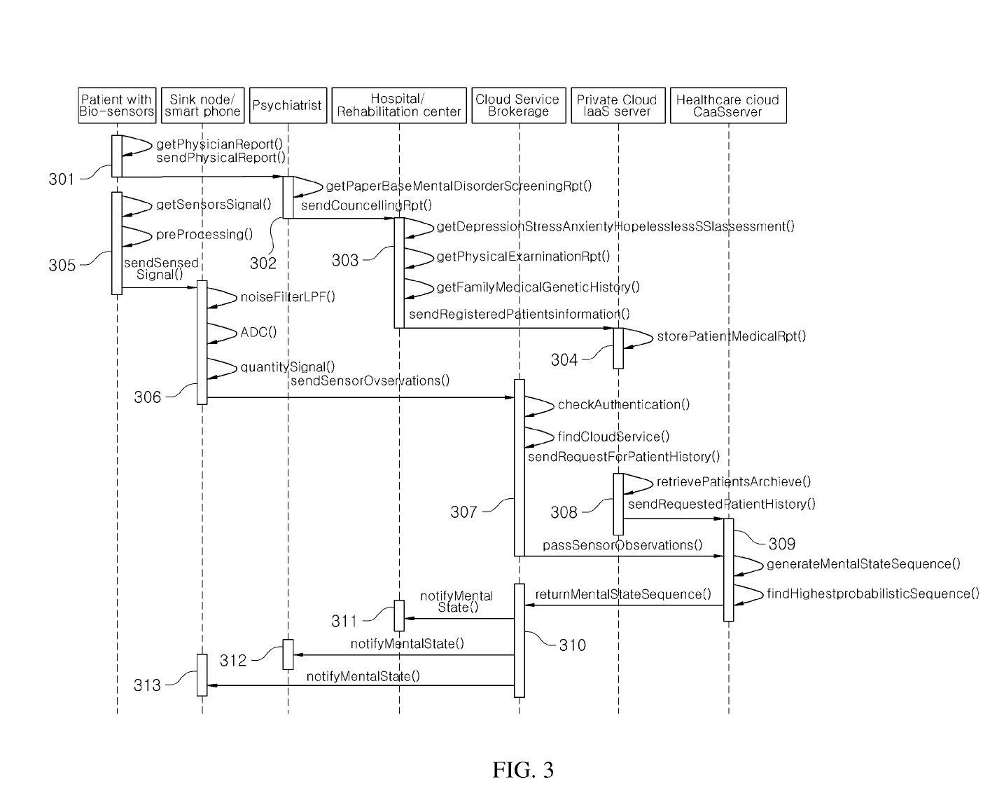

The cooperative operation between the functional units of the entire system 100 for the emergency telepsychiatry can be confirmed through a sequence diagram of FIG. 3 later.

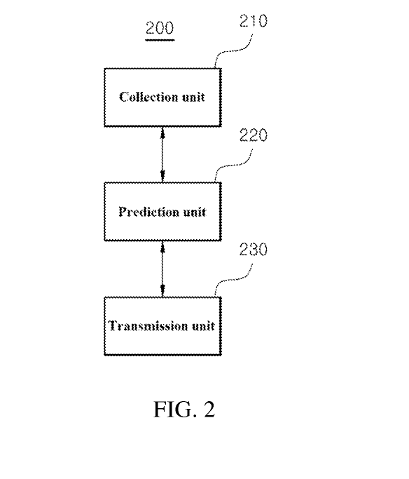

FIG. 2 is a block diagram illustrating the configuration of an emergency telepsychiatry system in accordance with an embodiment of the present invention.

The emergency telepsychiatry system 200 in accordance with an embodiment of the present invention may be included in at least one functional unit of the entire system for the emergency telepsychiatry

For example, the emergency telepsychiatry system 200 in accordance with the embodiment of FIG. 2 can be understood as a part of a configuration cloud service provider (CSP) unit 130.

To this end, the emergency telepsychiatry system 200 in accordance with an embodiment of the present invention includes a collection unit 210, a prediction unit 220, and a transmission unit 230.

First, the collection unit 210 in accordance with an embodiment of the present invention can collect real-time mental health symptoms and medical and family history data of a patient.

More specifically, the collection unit 210 in accordance with an embodiment of the present invention can collect the real-time mental health symptoms from the wireless body area network (WBAN) of the patient through the cloud service brokerage (CSB) unit 120 (or server). In other words, the real-time mental health symptoms of the patient can be observed by at least one sensor positioned at a part of the patient's body and can be based on information regarding sensor observations which are integrated by a sink node.

Besides, the collection unit 210 can collect the medical history data and family history data of the patient from the private IaaS cloud of the hospital or rehabilitation center through the cloud service brokerage (CSB) unit in response to a request of the cloud service brokerage (CSB) unit.

In accordance with an embodiment of the present invention, the prediction unit 220 can predict a psychiatric mental state of the patient based on the collected real-time mental health symptoms and medical and family history data of the patient.

In accordance with an embodiment of the present invention, the prediction unit 220 can model the collected real-time mental health symptoms and medical and family history data as the discrete set of states of hidden Markov model (HMM) using the hidden Markov model (HMM). In addition, the prediction unit 220 can predict a psychiatric mental state of the patient based on the modeled real-time mental health symptoms and medical and family history data.

More specifically, for example, the prediction unit 220 trains a machine learning algorithm using results of observations of hidden Markov model (HMM) as parameters according to the modeling, and generates a psychiatric mental state sequence based on the trained machine learning algorithm.

The machine learning algorithm may include a Viterbi algorithm.

In accordance with an embodiment of the present invention, the prediction unit may predict the prognosis of an emergency psychiatric state from the generated psychiatric mental state sequence.

In addition, the prediction unit 220 predicts the prognosis of an emergency psychiatric state from the generated psychiatric mental state sequence so that the psychiatric mental state of the patient can be predicted. The machine learning algorithm may use a Viterbi algorithm.

In accordance with an embodiment of the present invention, the transmission unit 230 can provide the predicted psychiatric mental state of the patient.

For example, the transmission unit 230 can provide the predicted psychiatric mental state to the cloud service brokerage (CSB) unit, and can transmits the predicted psychiatric mental state to the patient, a psychiatrist, a unit of the hospital through the cloud service brokerage (CSB) unit.

FIG. 3 is a sequence diagram illustrating an interaction between and operating sequence of functional units of a system model accordance with an embodiment of the present invention.

Entities as shown in FIG. 3 include bio-sensors for sensing the patient's body change, i.e., a patient with bio-sensors, a sink node or a smart phone for integrating sensing information, processing signals, and transiting the processed signals to the outside, a hospital or rehabilitation center, a cloud service brokerage (CSB) unit, a private cloud IaaS server, and a healthcare cloud CaaS server.

First, the bio-sensors (or the patient with bio-sensors) sense a patient's body change and transmit a signal indicative of the sensed patient's body change to the psychiatrist unit as shown in a reference numeral 301 of FIG. 3.

The psychiatrist receives the signal from the bio-sensors, makes a report based on the mental disorder screening, and provides a corresponding report to the hospital or rehabilitation center through the psychiatrist unit as shown in a reference numeral 302 of FIG. 3.

The hospital or rehabilitation center receives the report, acquires depression, stress, anxiety, and hopelessness of the patient based on the received report, and performs a physical examination on the patient as shown in a reference numeral 303 of FIG. 3. In addition, the hospital or rehabilitation center acquires the medical history of the patient's family by referring to the hospital records of the patient's family along with the physical examination on the patient, and registers the acquired medical history as the medical and family history data of the patient.

The private cloud server can store and maintain the medical and family history data of the patient.

As shown in a reference numeral 305 of FIG. 3, the bio-sensors (or patient with bio-sensors) can acquire sensing information from a specific body site of the patient. Thus, the bio-sensors can pre-process the acquired sensing information, and then transmit the pre-processed sensing information to the sink node such as the smart phone.

As shown in a reference numeral 306 of FIG. 3, the sink node can remove a noise from the received sensing information, digital-convert the noise-removed sensing information, and transmit the digital-converted sensing information to the cloud service brokerage (CSB) unit.

As shown in a reference numeral 307 of FIG. 3, the cloud service brokerage (CSB) unit can check whether or not the sensing information is valid through an authentication process of the sensing information. If the validity of the sensing information is authenticated, the cloud service brokerage (CSB) unit can request the medical history data of the patient, and family history data of the patient from the private cloud IaaS server, and provide the sensing information whose validity has been authenticated to the healthcare cloud CaaS server.

As shown in a reference numeral 308 of FIG. 3, the private cloud IaaS server can provide the medical history data of the patient, and family history data of the patient to the healthcare cloud CaaS server in response to a request of the cloud service brokerage (CSB).

As shown in a reference numeral 309 of FIG. 3, the healthcare cloud CaaS server can generate a psychiatric mental state sequence using the medical history data and family history data of the patient applied thereto from the private cloud IaaS server and the sensing information applied thereto from the cloud service brokerage (CSB), and find the most probable psychiatric mental state sequence. In addition, the healthcare cloud CaaS server can provide a result of the finding to the cloud service brokerage (CSB) unit.

As shown in a reference numeral 310 of FIG. 3, the cloud service brokerage (CSB) unit can provide the result of the finding applied thereto from the healthcare cloud CaaS server to the hospital or rehabilitation center, the psychiatrist unit, and the patient. (See reference numerals 311, 312, and 313).

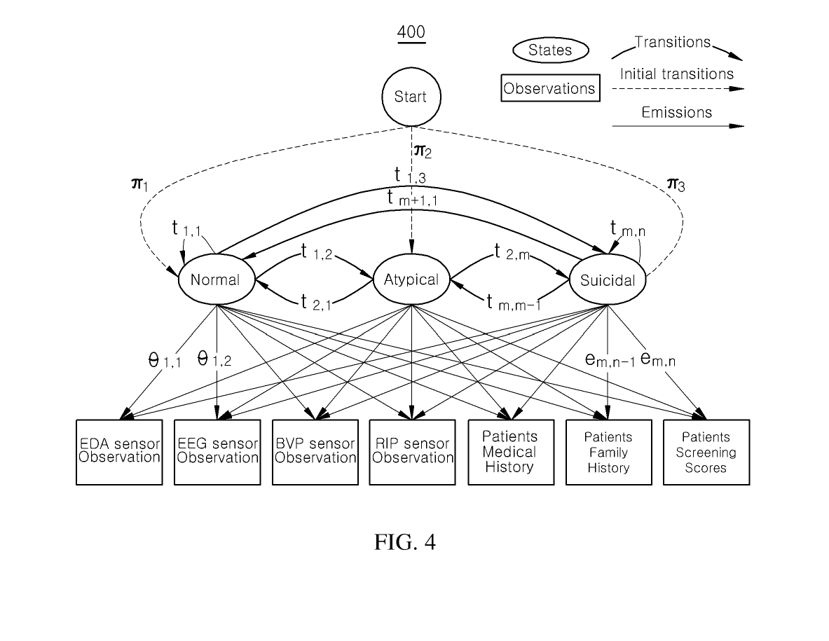

FIG. 4 is a diagrammatic view illustrating a hidden Markov model (HMM)-based mental state model for predicting an emergency psychiatric mental state.

In FIG. 4, there are shown defined parameters of initial, transition and emission probabilities, and a hidden Markov model (HMM) 400.

The psychiatric mental state monitoring is the most important in the emergency telepsychiatry. Thus, the success of the emergency telepsychiatry persistently depends upon accurate and just-in-time determination of life-threatening mental states. As far as we know there is no such pathological diagnosis which can pinpoint the atypical and emergency mental states. Therefore, a modeling method that can provide a statistically predictable estimation such as the hidden Markov model (HMM) 400 can prepare for the atypical and emergency mental states.

To model the emergency psychiatry system, psychiatric mental states can be considered to be hidden states. The psychiatric mental states are not fully or partially observable, but are predictable through some bio-sensor observations, personal medical records, personal and family histories, and genetic records.

The future psychiatric mental state of a patient depends on the current state of the patient exclusively.

Thus, the hidden Markov model (HMM) is barely apposite to model psychiatric mental states of individuals.

In the hidden Markov model (HMM), 400 for predicting the psychiatric mental state, total M states can be considered in the recommended discrete time Markov process and a set of states can be defined as S={s₁, s₂, . . . , s_{M}}, where all states are hidden.

The observations can be partially fetched from the patient's body through the wireless body area network (WBAN) of the patient, and can be partially fetched from a cloud storage means, i.e., the patient's traits, personal and family histories, and genetic records.

To model the emergency psychiatry system, the symbolic representation of the observations set can be considered as follows: O={o₁, o₂, . . . , o_{N}}, where N is the number of total observations.

To predict the psychiatric mental states, the primary goal in the hidden Markov model (HMM) 400 is to find out the most probable psychiatric mental state sequence Q={q₁, q₂, . . . , qₚ}∈S based on the perceived observations V={v₁, v₂, . . . , vₚ}∈O at a given time t.

The defined hidden Markov model (HMM) of mental states has three tuples, i.e., Hidden Markov Model λ={π, T, E}, where π is a set of initial states probabilities and can be interpreted as follows: π={πᵢ|πᵢ=P(sᵢ)}, where i=1, 2, 3 . . . , M.

To predict the psychiatric mental states, in the hidden Markov model (HMM) 400, state transition probabilities (T) can be defined as follows:

T={tᵢⱼ|tᵢⱼ=P(sⱼ|sᵢ)},

where i=1, 2, 3 . . . M, and j=1, 2, 3 . . . M.

To predict the psychiatric mental states, in the hidden Markov model (HMM) 400, emission probabilities E can be defined as follows:

E={eᵢₖ|eᵢₖ=P(oₖ|sᵢ)},

where i=1, 2, 3 . . . M, and k=1, 2, 3 . . . , N.

Hereinafter, an embodiment of a training process and a verification of the hidden Markov model (HMM) will be described.

The determination of tuples of the hidden Markov model (HMM) is required to distribute a predicted psychiatric mental state model of the emergency telepsychiatry.

The Baum-Welch algorithm is one of common methods used to determine parameters of initial, transition and emission probabilities.

In comparison of the convergence time, a light Viterbi path counting (VPC) training algorithm is relatively efficient as compared to the Baum-Welch algorithm used to determine the HMM parameters. In the present invention, a psychiatric mental state model is trained through the VPC training algorithm using a reference dataset to determine the HMM parameters which are to be used in the following equations (1), (2) and (3):

$$\begin{matrix}\overline{{π}_{1}} = Expected number of occurrences in state {s}_{i} at the starting time & ( 1 ) \\ \overline{{t}_{ij}} = \frac{Frequency of transitions from {s}_{i} to state {s}_{j}}{Frequency of transitions from {s}_{i}} & ( 2 ) \\ \overline{{e}_{ij}} = \frac{Frequency of being in state j and observing symbol {v}_{i}}{Frequency of being in state j} . & ( 3 )\end{matrix}$$

The reference datasets are not designed for special requirements of the emergency telepsychiatry. To this end, the revised dataset may be prepared for a training, a verification, and a test of the psychiatric mental state model.

The missing data of the revised dataset can be prophesied by an Expectation-Maximization algorithm.

The main goal of the emergency mental state prediction model for the emergency telepsychiatry is to generate the posteriori psychiatric mental state sequence based on the observations.

The MSSG unit of the healthcare cloud can find out a psychiatric mental state sequence of a psychiatric patient in the emergency telepsychiatry using the Viterbi algorithm and the probabilistic mental state model.

The prognosis of a suicidal mental state is determined from the psychiatric mental state sequence generated by the MSSG.

If the generated psychiatric mental state sequence is substituted into Q={q₁, q₂, . . . , qₚ}, the frequency of each state can be counted to predict the prognosis of the suicidal mental state.

As a set of states is defined as S={s₁, s₂, . . . , s_{M}}, the cardinality of each of the states (i.e., |s₁|, |s₂|, . . . , |s_{M}|) can be identified in the generated state sequence Q.

That is, Ŝ=arg maxᵢ |sᵢ| can be used to predict the current psychiatric state of the patient. If the current psychiatric state of the patient is predicted as Ŝ∈ {‘suicide’}, then the state of the patient can be classified as ‘emergency’.

In this case, the threshold valve Tₛ can be selected to maximize a ratio of a true positive to a true negative while minimizing a ratio of a false negative to a true negative.

The optimal threshold valve Tₛ can be set only for suicide. In other words, the emergency telepsychiatry system generates the psychiatric mental state sequence Q using the Viterbi algorithm (λ), and determines each of the states |sᵢ| from the generated psychiatric mental state sequence Q. If Ŝ is greater than Tₛ, then the current psychiatric state of the patient can be set to be emergency.

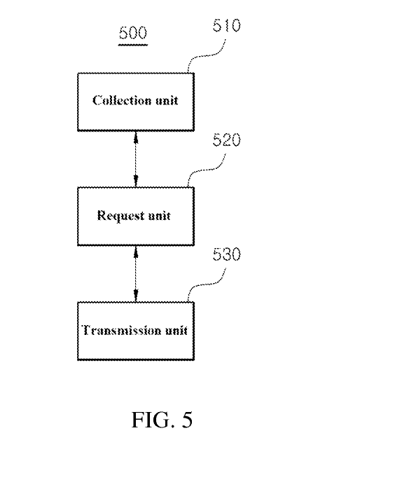

FIG. 5 is a block diagram illustrating the configuration of an emergency telepsychiatry system 500 in accordance with another embodiment of the present invention.

The emergency telepsychiatry system 500 in accordance with another embodiment of the present invention may be included in at least one functional unit of the entire system for the emergency telepsychiatry.

For example, the emergency telepsychiatry system 500 in accordance with the embodiment of FIG. 5 can be understood as a part of a configuration cloud service brokerage (CSB) unit 120.

The emergency telepsychiatry system 500 in accordance with another embodiment of the present invention includes a collection unit 510, a request unit 520, and a transmission unit 530.

The collection unit 510 in accordance with another embodiment of the present invention can collect real-time mental health symptoms of a patient. In this case, the collection unit 510 can collect the real-time mental health symptoms from the wireless body area network (WBAN) of the patient.

The request unit 520 in accordance with another embodiment of the present invention can request a private cloud server to transmit history information regarding the patient to a healthcare cloud server if the collected real-time mental health symptoms of the patient are authenticated. The healthcare cloud server can receive medical history data and family history data of the patient according to this request.

In addition, the transmission unit 530 in accordance with another embodiment of the present invention can transmit the collected real-time mental health symptoms of the patient to the healthcare cloud server.

As such, the healthcare cloud server can collect the real-time mental health symptoms, and the medical history data and family history data of the patient.

The healthcare cloud server can receive a predicted psychiatric mental state in response to the transmission of the collected real-time mental health symptoms of the patient from the transmission unit, and predict the psychiatric mental state using the real-time mental health symptoms and the history information regarding the patient.

More specifically, the healthcare cloud server can model the collected real-time mental health symptoms and medical and family history data as the discrete set of states of hidden Markov model (HMM) using the hidden Markov model (HMM). In addition, healthcare cloud server can train a machine learning algorithm using results of observations of hidden Markov model (HMM) according to the modeling as parameters, and generate a psychiatric mental state sequence based on the trained machine learning algorithm to predict the psychiatric mental state of the patient.

Further, the history information regarding the patient can include at least one of medical data of the patient and family history data of the patient.

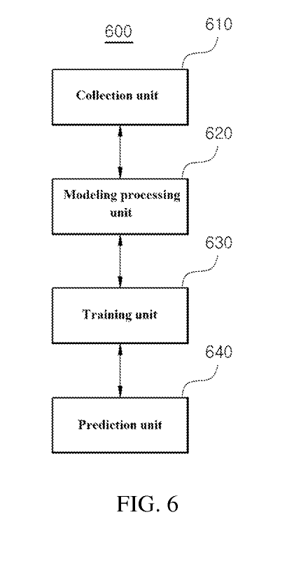

FIG. 6 is a block diagram illustrating the configuration of an emergency telepsychiatry system 600 in accordance with still another embodiment of the present invention.

The emergency telepsychiatry system 600 includes a collection unit 610, a modeling processing unit 620, a training unit 630, and a prediction unit 640.

First, the collection unit 610 in accordance with still another embodiment of the present invention can collect real-time mental health symptoms of a patient, medical history data of the patient, and family history data of the patient.

The modeling processing unit 620 can model the collected real-time mental health symptoms and medical and family history data of the patient using the hidden Markov model (HMM). For example, the modeling processing unit 620 can model the collected real-time mental health symptoms and medical and family history data of the patient as the discrete set of states of hidden Markov model (HMM) using the hidden Markov model (HMM). In addition, the modeling processing unit 620 may use a Viterbi algorithm as the machine learning algorithm.

The training unit 630 can train a machine learning algorithm using results of observations of hidden Markov model (HMM) according to the modeling as parameters. The prediction unit 640 can generate a psychiatric mental state sequence based on the trained machine learning algorithm to predict the psychiatric mental state of the patient.

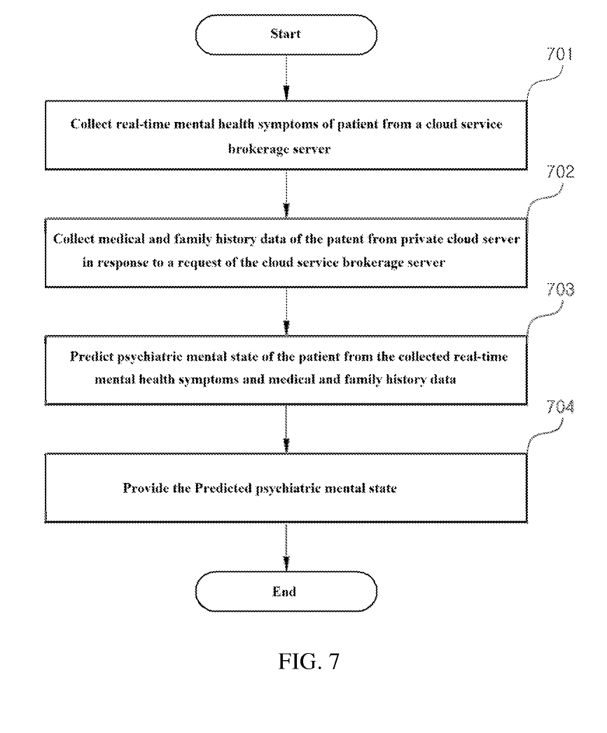

FIG. 7 is a flow chart illustrating a process for operating an emergency telepsychiatry system in accordance with an embodiment of the present invention.

In a method for operating an emergency telepsychiatry system in accordance with an embodiment of the present invention, real-time mental health symptoms of a patient is collected from a cloud service brokerage server (step 701).

In addition, in the method for operating an emergency telepsychiatry system in accordance with an embodiment of the present invention, the medical and family history data of the patent can be collected from a private cloud server in response to a request of the cloud service brokerage server (step 702).

As such, in the method for operating an emergency telepsychiatry system in accordance with an embodiment of the present invention, the real-time mental health symptoms and the medical and family history data of the patient can be collected.

Subsequently, in the method for operating an emergency telepsychiatry system in accordance with an embodiment of the present invention, a psychiatric mental state of the patient can be predicted from the collected real-time mental health symptoms and medical and family history data of the patient (step 703).

In the method for operating an emergency telepsychiatry system in accordance with an embodiment of the present invention, a machine learning algorithm can be trained using results of observations of hidden Markov model (HMM) according to the modeling as parameters, and a psychiatric mental state sequence can be generated based on the trained machine learning algorithm. In addition, the prediction unit 220 can predict the prognosis of an emergency psychiatric state from the generated psychiatric mental state sequence to predict the psychiatric mental state of the patient.

In the method for operating an emergency telepsychiatry system in accordance with an embodiment of the present invention, the predicted psychiatric mental state can be provided (step 704).

For example, in the method for operating an emergency telepsychiatry system in accordance with an embodiment of the present invention, the predicted psychiatric mental state can be provided to the cloud service brokerage (CSB) unit, which in turn transmits the predicted psychiatric mental state to the patient, the psychiatrist, and the hospital or rehabilitation center unit.

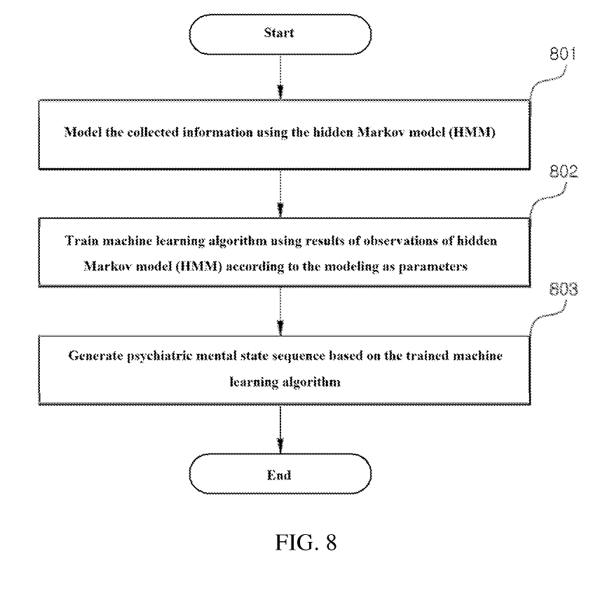

FIG. 8 is a flow chart illustrating a hidden Markov model (HMM)-based mental state modeling process.

In the method for operating an emergency telepsychiatry system in accordance with an embodiment of the present invention, the collected information can be modeled using the hidden Markov model (HMM) (step 801).

A machine learning algorithm can be trained using results of observations of hidden Markov model (HMM) according to the modeling as parameters (step 802), and the psychiatric mental state sequence can be generated based on the trained machine learning algorithm (step 803).

The method for operating an emergency telepsychiatry system in accordance with the embodiment of the present invention can be implemented in the form of a program command that can be executed by various pieces of computer means and recorded on a computer-readable recording medium. The computer-readable recording medium can include a program command, a data file, and a data structure solely or in combination. The program command recorded on the recording medium might have been specially designed and configured for the present invention or may be known or available to a person who is skilled in computer software. Examples of the computer-readable recording medium include: magnetic media such as a hard disk, a floppy disk and a magnetic tape; optical media such as a compact-disc read only memory (CD-ROM) and a digital versatile disc (DVD); magnet-optical media such as a floptical disk; and a hardware device specially configured to store and execute the program command, such as a ROM, a random access memory (RAM), a flash memory, etc. Examples of the program command include not only a machine code generated by a compiler, but also a high-level language code executable by a computer using an interpreter or the like. The hardware device may be configured to operate one or more software modules for implementing the method according to an exemplary embodiment of the present invention, and the vice versa.

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. For example, although the techniques described above are performed in an order different from that of the method described above, and/or the elements such as the system, the structure, and the circuit that are described above are coupled or combined in an form different from that of the method described above or are replaced or substituted by other elements or equivalents, a proper result can be achieved.

Accordingly, other embodiments, and all the equivalent modifications of the claims should be construed as falling within the scope of the present invention as defined by the appended claims.

1. An emergency telepsychiatry system comprising:
a collection unit for collecting real-time mental health symptoms and medical and family history data of a patient;
a prediction unit for predicting a psychiatric mental state of the patient from the collected real-time mental health symptoms and medical and family history data; and
a transmission unit for providing the predicted psychiatric mental state of the patient.

2. The emergency telepsychiatry system according to claim 1, wherein the real-time mental health symptoms of the patient are observed by at least one sensor positioned at a part of the patient's body and are based on information regarding sensor observations which are integrated by a sink node.

3. The emergency telepsychiatry system according to claim 1, wherein the collection unit collects the real-time mental health symptoms of the patient from a cloud service brokerage server, and collects the medical history data and family history data of the patient from a private cloud server in response to a request of the cloud service brokerage server.

4. The emergency telepsychiatry system according to claim 1, wherein the prediction unit models the collected real-time mental health symptoms and medical and family history data as the discrete set of states of hidden Markov model (HMM) using the hidden Markov model (HMM), and predicts the psychiatric mental state of the patient based on the modeled real-time mental health symptoms and medical and family history data.

5. The emergency telepsychiatry system according to claim 4, wherein the prediction unit trains a machine learning algorithm using results of observations of hidden Markov model (HMM) according to the modeling as parameters, and generates a psychiatric mental state sequence based on the trained machine learning algorithm.

6. The emergency telepsychiatry system according to claim 5, wherein the machine learning algorithm comprises a Viterbi algorithm.

7. The emergency telepsychiatry system according to claim 5, wherein the prediction unit predicts the prognosis of an emergency psychiatric state from the generated psychiatric mental state sequence.

8. An emergency telepsychiatry system comprising:
a collection unit for collecting real-time mental health symptoms of a patient;
a request unit for requesting a private cloud server to transmit history information regarding the patient to a healthcare cloud server if the collected real-time mental health symptoms of the patient are authenticated; and
a transmission unit for transmitting the collected real-time mental health symptoms of the patient to the healthcare cloud server,
wherein the healthcare cloud server receives a predicted psychiatric mental state in response to the transmission of the collected real-time mental health symptoms of the patient from the transmission unit, and predicts the psychiatric mental state using the real-time mental health symptoms and the history information regarding the patient.

9. The emergency telepsychiatry system according to claim 8, wherein the history information regarding the patient comprises at least one of medical data of the patient and family history data of the patient.

10. The emergency telepsychiatry system according to claim 8, wherein the healthcare cloud server models the collected real-time mental health symptoms and medical and family history data as the discrete set of states of hidden Markov model (HMM) using the hidden Markov model (HMM), trains a machine learning algorithm using results of observations of hidden Markov model (HMM) according to the modeling as parameters, and generates a psychiatric mental state sequence based on the trained machine learning algorithm to predict the psychiatric mental state of the patient.

11. An emergency telepsychiatry system comprising:
a collection unit for collecting real-time mental health symptoms of a patient, medical history data of the patient, and family history data of the patient;
a modeling processing unit for modeling the collected real-time mental health symptoms and medical and family history data of the patient using a hidden Markov model (HMM);
a training unit for training a machine learning algorithm using results of observations of hidden Markov model (HMM) according to the modeling as parameters; and
a prediction unit for generating a psychiatric mental state sequence based on the trained machine learning algorithm to predict the psychiatric mental state of the patient.

12. The emergency telepsychiatry system according to claim 11, wherein the modeling processing unit models the collected real-time mental health symptoms and medical and family history data of the patient as the discrete set of states of hidden Markov model (HMM) using the hidden Markov model (HMM).

13. The emergency telepsychiatry system according to claim 11, wherein the modeling processing unit uses a Viterbi algorithm as the machine learning algorithm.

14. A method for operating an emergency telepsychiatry system, the method comprising the steps of:
allowing a collection unit to collect real-time mental health symptoms and medical and family history data of a patient
allowing a prediction unit to predict a psychiatric mental state of the patient from the collected real-time mental health symptoms and medical and family history data; and
allowing a transmission unit to providing the predicted psychiatric mental state.

15. The method according to claim 14, wherein the step of allowing a collection unit to collect real-time mental health symptoms and medical and family history data comprises the steps of:
collecting the real-time mental health symptoms from a cloud service brokerage server; and
collecting the medical and family history data from a private cloud server in response to a request of the cloud service brokerage server.

16. The method according to claim 14, wherein the step of allowing a prediction unit to predict a psychiatric mental state of the patient comprises the steps of:
modeling the collected real-time mental health symptoms and medical and family history data as the discrete set of states of hidden Markov model (HMM) using the hidden Markov model (HMM);
training a machine learning algorithm using results of observations of hidden Markov model (HMM) according to the modeling as parameters, and
generating a psychiatric mental state sequence based on the trained machine learning algorithm.

17. A computer-readable recording medium having recorded thereon a program for executing the method according to claim 14.

18. A computer-readable recording medium having recorded thereon a program for executing the method according to claim 15.

19. A computer-readable recording medium having recorded thereon a program for executing the method according to claim 16.
